(19) United States
(12) Patent Application Publication
(10) Pub. No.: US 2005/0035724 A1
(43) Pub. Date: Feb. 17, 2005

(54) Electronic circuit, and method of operating a high-pressure lamp

(76) Inventor: Peter Lurkens, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/500,507

(22) PCT Filed: Dec. 18, 2002
(86) PCT No.: PCT/IB02/05746

(30) Foreign Application Priority Data
Jan. 2, 2002 (DE) 102 00 004.2

(51) Int. Cl. H05B 37/02

(52) U.S. Cl. 315/291; 315/307; 315/244

(57) ABSTRACT

The invention relates to an electronic circuit and to a method of operating a high-pressure lamp in various operational modes. The circuit comprises a DC-AC converter consisting of two bridges (110-1) and (110-2). A series circuit comprising a first coil L1, the high-pressure lamp (120), and a second coil L2 is connected between the outputs (112-1) and (112-2) of these two half bridges. The invention has for its obeject to develop such a known circuit further such that it is equally suitable for an ignition mode and for a normal operational mode of the high-pressure lamp, without individual components having to be overdimensioned. According to the invention, this object is achieved in that a first capacitor C1 is connected in a path from the junction point of the first coil L1 and the high-pressure lamp (120) either to a reference potential (−) or to an operating potential (+), and in that a second capacitor C2 is connected in the path from the junction point of the high-pressure lamp (120) and the second coil L2 either to the reference potential (−) or to the operating potential (+) or in parallel to the high-pressure lamp (120).

The invention relates to an electronic circuit and to a method of operating a high-pressure lamp in an ignition mode and in a normal operational mode.

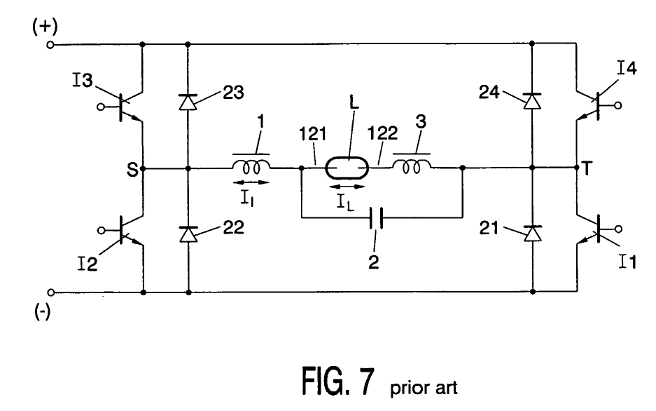

Such circuits are known from the prior art, for example from U.S. Pat. No. 4,734,624. The circuit known from the cited US document is shown in FIG. 7 and will be explained in detail below. It comprises a DC-AC converter which comprises the four transistors I1, I2, I3, and I4, such that the transistors I2 and I3, as well as I1 and I4 are connected in series, respectively, thus forming a half bridge each time. The two half bridges are connected in parallel between an operating potential (+) and a reference potential (−). A freewheel diode 21 to 24 is connected in parallel to each of the individual transistors I1 to I4. The half bridges act as a DC-AC converter and provide a suitable AC current for the operation of the high-pressure lamp in the ignition mode or in the normal operational mode. The high-pressure lamp itself forms part of a series circuit comprising a first coil 1, followed by the high-pressure lamp L, and followed again by a second coil 3. This series circuit is connected between the outputs S and T of the two half bridges. The series circuit is completed with a capacitor 2 which is connected in parallel to the high-pressure lamp L and the second coil 3.

As long as the high-pressure lamp has not been ignited, it represents an interruption of said series circuit. This interruption, however, is bridged by the capacitor 2, so that the two half bridges are interconnected by the capacitor 2. An independent operation of the two half bridges is accordingly not possible, also in the non-ignited state of the high-pressure lamp L.

The first coil 1 and the capacitor 2 are to be dimensioned for the normal operational mode such that they act as a filter for filtering out the AC component from the lamp current. They are definitely not operated in a resonant mode during this, i.e. the switching frequencies of the two transistors I2 and I3 are substantially higher than the resonance frequency of a resonant circuit formed by the first coil 1 and the capacitor 2.

The first coil 1 and the capacitor 2 are to be operated at their resonance frequency in the ignition mode by contrast, so as to generate a high voltage required for igniting the high-pressure lamp L. It is necessary for this that the capacitor 2 is constructed so as to be resistant to high voltages, i.e. for a few kV. In addition, the first coil 1 should be dimensioned such that it does not enter the saturated state even when loaded by an ignition current, which is approximately ten times stronger than the current during normal operation.

The prior art embodiments show that a completely different dimensioning of the components, in particular of the first coil 1 and the capacitor 2, is necessary for the ignition mode as compared with the normal operational mode. The circuit known from the prior art and shown in FIG. 7, therefore, can be usefully employed basically either for an ignition mode or for a normal operational mode. It is indeed possible to use the circuit of FIG. 7 for a combination of ignition mode and normal operational mode, but in that case the first coil 1 and the capacitor 2 will be strongly overdimensioned for the normal operational mode if it is to be capable of realizing the ignition mode as well.

A further disadvantage of the circuit of FIG. 7 is that strong high-frequency synchronous interference voltages, which arise during switching of the switching elements I1 . . . I4, can be transmitted unchecked to the connection lines 121, 122 of the high-pressure lamp L because the two half bridges are not decoupled, but are coupled via the capacitor 2. Losses will eventually occur during switching of the transistors I1 . . . I4 which are higher in proportion as the switching frequencies are higher. No measures are taken in the circuit of FIG. 7 for reducing these losses.

Starting from the cited US patent, it is accordingly an object of the invention to develop the circuit for supplying high-pressure lamps disclosed therein further such that it renders possible both an ignition mode and a normal operational mode, i.e. a stable continuous operation, of a high-pressure lamp without the components of the circuit having to be overdimensioned.

This object is achieved by the characterizing features of claim 1. More accurately, the object of the invention is achieved in that the capacitor 2 known from FIG. 7, denoted first capacitor hereinafter, is switched from the junction point between the first coil and the high-pressure lamp either to the reference potential or to the operating potential, and in that a second capacitor is provided, which is switched from the junction point between the high-pressure lamp and the second coil either to the reference potential or to the operating potential or in parallel to the high-pressure lamp.

The arrangement of the capacitors in accordance with the invention achieves that the two half bridges are operated in a decoupled manner in principle, i.e. at least as long as the high-pressure lamp is not ignited. This is also true for the case in which the second capacitor is connected in parallel to the high-pressure lamp, because according to the invention at least the high-frequency components can be drained off via the common junction point—i.e. between the first coil and the high-pressure lamp—and the first capacitor also in this case.

The decoupling of the two half bridges described above renders possible an independent construction and dimensioning of both a first resonant circuit, also denoted filter circuit, comprising the first coil and the first capacitor for filtering out high-frequency components from the lamp current, in particular in the operational mode, and of a second resonant circuit comprising the second coil and the second capacitor for igniting the high-pressure lamp in the ignition mode. The second coil fulfills an additional filtering function in the operational mode in that it filters out high-frequency components from the lamp current.

The circuit according to the invention thus renders it possible to realize a filtering function in the normal operational mode as well as an ignition function in an ignition mode by means of independent circuit elements, i.e. the filter circuit and the second resonant circuit. The two resonant circuits are dimensioned and operated independently of one another. An overdimensioning of in particular the first coil and the first capacitor in the filter circuit is not necessary, according to the invention, because the filter circuit does not have to realize also the ignition function.

Furthermore, the two terminals of the high-pressure lamp according to the invention are connected either to the operating potential or to the reference potential via the first and the second capacitor—at least for high-frequency components. The high-frequency interference peaks arising in the half bridges, for example owing to switching of the switching elements, are automatically and advantageously drained off through the capacitors before reaching the high-pressure lamp in this manner. The actual current through the high-pressure lamp itself is accordingly advantageously at least substantially free from HF interference peaks. The supply leads to the high-pressure lamp are also free from DC interference voltages then.

To reduce the switching losses in the transistors of the half bridges, various embodiments for capacitor arrangements connected in parallel to the transistors are proposed in the dependent claims.

Advantageously, the circuit according to the invention comprises a current control for adjusting the amplitude of the current through the high-pressure lamp.

The object of the invention mentioned above is furthermore achieved by a method of operating a high-pressure lamp as claimed in claim 8. The advantages of this method correspond substantially to the advantages mentioned above for the circuit. In addition to these advantages, the claimed method offers the possibility of operating the second resonant circuit L2, C2 not only at its natural resonant frequency, but alternatively also at an odd fraction of its resonant frequency, which has the advantage that the losses in the ignition mode are clearly reduced, in particular in the switching elements of the second half bridge.

Further advantageous embodiments of the circuit according to the invention and of the method according to the invention for the operation thereof are the subject of the dependent claims.

The invention is illustrated in seven Figures, in which:

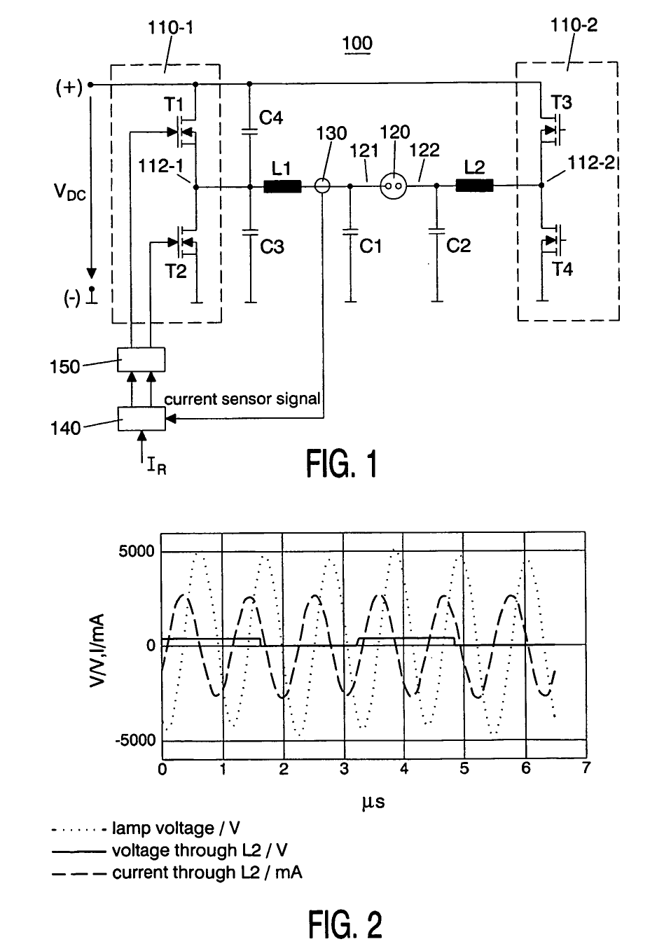

FIG. 1 shows a first embodiment of the circuit according to the invention;

FIG. 2 shows the lamp voltage during resonant excitation in the ignition mode;

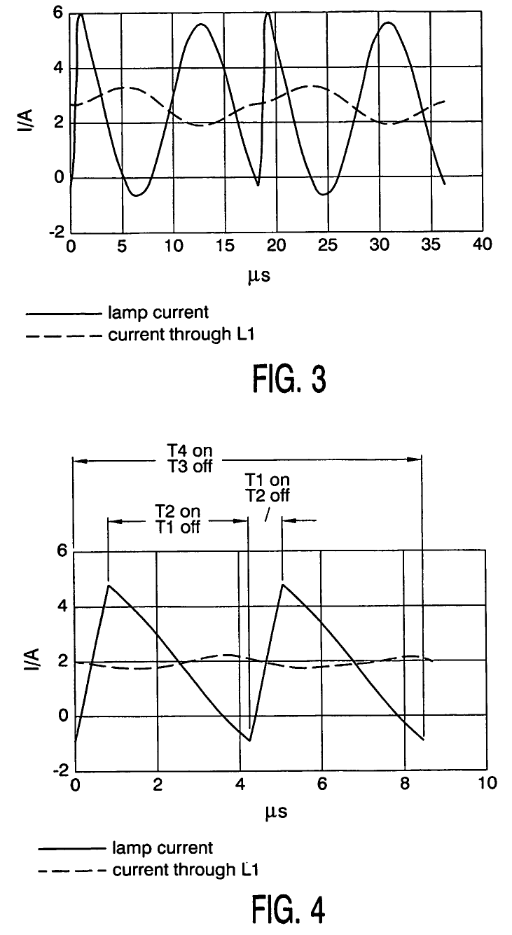

FIG. 3 shows the lamp current in a run-up phase of the high-pressure lamp;

FIG. 4 shows the lamp current in a positive half wave in the normal operational mode;

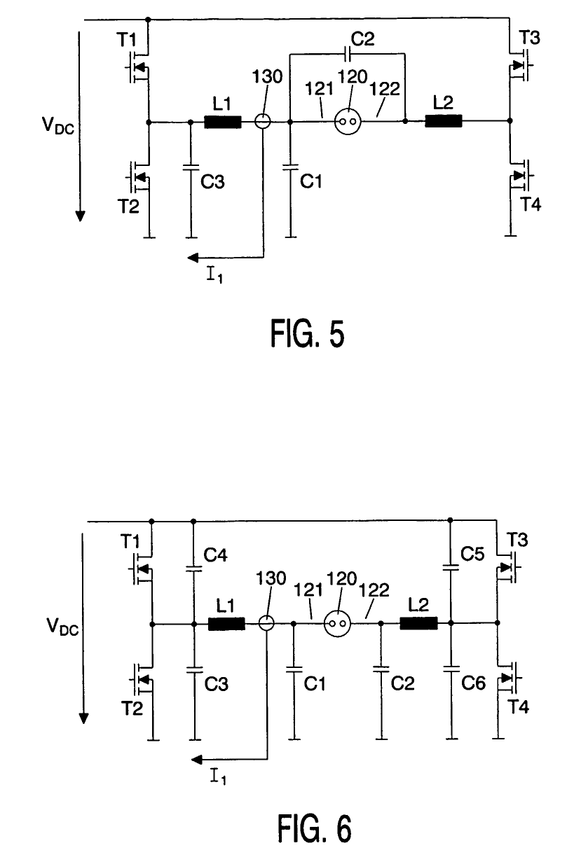

FIG. 5 shows a second embodiment of the circuit according to the invention;

FIG. 6 shows a third embodiment of the claimed electronic circuit; and

FIG. 7 shows a circuit known from the prior art for operating a high-pressure lamp.

The hardware construction of a preferred embodiment of the claimed circuit will be explained in detail below with reference to FIG. 1, followed by an explanation of its operation in various operational modes with reference to FIGS. 2 to 4.

FIG. 1 shows a preferred embodiment of the electronic circuit 100 according to the invention for operating a high-pressure lamp 120 in various operational modes, in particular in an ignition mode, a run-up mode, and a normal operational mode.

The circuit 100 comprises a DC-AC converter consisting of a first half bridge 110-1 and a second half bridge 110-2 for providing a suitable alternating current for the high-pressure lamp 120 in said operational modes. The first half bridge 110-1 consists of two switching elements connected in series, preferably power transistors T1, T2, a DC voltage V_{DC} being applied to this series arrangement. The DC voltage is given by a potential difference between an operating potential (+) and a reference potential (−). The second half bridge 110-2 is constructed so as to be symmetrical to the first half bridge 110-1. The second half-bridge 110-2 comprises two switching elements connected in series, preferably power transistors T3 and T4, which second half bridge 110-2 is connected to said DC voltage V_{DC} in parallel to the first half bridge 110-1.

In addition to the two half bridges 110-1, 110-2, the circuit 100 according to the invention comprises a series arrangement which connects the output 112-1 of the first half bridge 110-1 to the output 112-2 of the second half bridge 110-2. The series arrangement comprises a first coil L1, followed by the high-pressure lamp 120 connected via a first supply line 121, followed again by a second supply line 122 and a second coil L2. The connection terminal of the first coil L1 not connected to the high-pressure lamp 120 is connected to the output 112-1 of the first half bridge 110-1, and the connection terminal of the second coil L2 not connected to the high-pressure lamp 120 is connected to the output 112-2 of the second half bridge 110-2.

A first capacitor C1 is connected in the path from the junction point of the first coil L1 and the high-pressure lamp 120 either to the operating potential (+) (not shown in FIG. 1) or to the reference potential (−). In addition, a second capacitor C2 is connected in the path from the junction point of the high-pressure lamp 120 and the second coil L2 either to the operating potential (+) (not shown in FIG. 1) or to the reference potential (−) or in parallel to the high-pressure lamp 120 (shown in FIG. 5).

The embodiment of the electronic circuit according to the invention shown in FIG. 1 further comprises several components for achieving a control of the lamp current level. For this purpose, a sensor device 130 is provided between the first coil L1 and the connection terminal of the first capacitor C1 for generating a current sensor signal which represents the level of the current through the first coil L1. This current sensor signal is supplied to a comparator device 140 which compares the level of the current through the first coil L1 represented by the current sensor signal with a given reference current value I_{R}, generating control signals for achieving a suitable control of the switching elements T1, T2 of the first half bridge 110-1 in dependence on the result of this comparison. More in detail, said control signals are arranged such that they vary the duty cycles of the individual switching elements T1 and/or T2 of the first half bridge 110-1 such that the average value of the current through the first coil L1 is adjusted to the desired value of the lamp current. The duty cycle defines the ratio of the switch-on time of a switching element to the cycle duration, for example of the current. The control of the current through the first coil L1 at the same time controls the instantaneous value of the lamp current through the high-pressure lamp 120 because of the arrangement of the circuit according to the invention.

In addition to the comparator device 140 described above, a delay device 150 may be provided for delaying the control signals by a given delay time with respect to the moment when it is detected that the level becomes too high or too low in comparison with the reference current value I_{R}. This delay time has a damping influence of the control. The delay time is preferably chosen such that at least a desired critical damping adjusts itself in the filter circuit comprising the second coil L2 and the first capacitor C1, so that any control deviation detected is compensated without overshoot. At the same time, the delay time is adjusted such that the current through the first coil L1 changes its sign at least twice during one switching cycle.

The operation of the circuit described above and shown in FIG. 1 will be explained below for various operational modes.

1. Ignition Mode In the non-ignited state, the high-pressure lamp 120 is to be regarded as an interruption, i.e. it disconnects the first half bridge 110-1 with the filter circuit connected thereto, comprising the first coil 1 and the first capacitor C1, from the second half bridge 110-2 with the second resonant circuit connected thereto, comprising the second coil L2 and the second capacitor C2. This decoupling renders it possible to excite the second resonant circuit at its natural resonance frequency f_{R2} so as to make available a sufficiently high ignition voltage for the high-pressure lamp 120. The excitation of the resonance necessary for this in the second resonant circuit takes place such that the switching elements T3 and T4 of the second half bridge 110-2 are switched on and off in alternation either at said resonance frequency f_{R2} or an odd fraction thereof. The resonant resistance of the second resonant circuit is suitably chosen such that, at the ignition voltage of, for example, 5 kV necessary for the high-pressure lamp 120, the current in the second coil L2 is not higher than the maximum lamp current during a normal operational mode yet to be described below. Such a construction will lead to the high resonance frequency mentioned above.

If the desired ignition voltage is to be generated only through excitation of the second resonant circuit with an odd fraction, for example ⅕or ⅓, of the resonance frequency f_{R2}, then the minimum quality of the second resonant circuit must be made correspondingly higher. FIG. 2 shows the current and voltage gradients in the second coil L2 and the resulting ignition voltage for the high-pressure lamp 120 in the case of resonant excitation of the ignition voltage by means of the third harmonic.

Typically, the first capacitor C1 is constructed so as to be considerably larger than the second capacitor C2; for example, C1=150 nF and C2=82 pF. In this construction, for example, the second coil L2 is so constructed that a resonance frequency overall of, for example, 1 MHz is obtained for the second resonant circuit.

According to the invention, the second resonant circuit is constructed such that it must be operated at its natural resonance frequency f_{R2} in the ignition mode during a comparatively short resonance period or ignition period of no more than a few seconds, for example 1 or 2 seconds, so as to achieve the ignition of the high-pressure lamp 120. This comparatively short ignition time according to the invention has the advantage that the switching elements T3 and T4 in the second half bridge 110-2 are also switched over at said resonance frequency or an odd fraction thereof during this short period only. The high-frequency switching operation of the switching elements T3 and T4 give rise to high losses therein, but these are acceptable because of the short duration of the ignition operation.

During ignition, the switching element T1 of the first switching bridge 110-1 is preferably fully switched on, whereas the second switching element T2 is switched off, so that the junction point between the first capacitor C1 and the high-pressure lamp 120 is permanently connected to a high potential. As long as the high-pressure lamp 120 has not yet ignited, i.e. no lamp current can flow, this lamp is not controlled by the first half bridge 110-1 either.

When the high-pressure lamp finally ignites, it will first be in a so-called glow discharge state. In the glow discharge state, the high-pressure lamp requires an operating voltage of approximately 300 V, which is substantially lower than the ignition voltage but still comparatively high in comparison with an operating voltage of 75 V necessary for normal operation, as will be described further below. In the glow discharge state, the voltage drop across the high-pressure lamp 120 serves as a countervoltage, and it is necessary to drive a sufficiently strong current through the high-pressure lamp 120 against this countervoltage for achieving that its electrodes heat up sufficiently, so that the high-pressure lamp 120 will enter a subsequent luminous arcing mode. The glow discharge operation damps the second resonant circuit C2, L2 to the extent that a voltage adjusts itself across the second coil L2 which is just sufficient for driving the required current through the high-pressure lamp 120. The drop in voltage across the second coil L2 also causes its current to drop to the same relative degree. If this current through the second coil L2 becomes too weak for providing a sufficiently strong current to the high-pressure lamp 120, this drop may be counteracted by a decrease in the operating frequency of the second resonant circuit. Alternatively to a drop in the operating frequency of the second resonant circuit, a switch may be made to normal operation as described further below, because here it is possible to generate at most the operational DC voltage V_{DC}, approximately 400 V, for the high-pressure lamp 120. It should be noted, however, that the operating voltage V_{DC} of the circuit is not identical to the average operating voltage of the high-pressure lamp 120 in normal operation, which lies at approximately 75 V, as was noted above.

If the ignition voltage for the high-pressure lamp 120 is not generated by the second resonant circuit C2, L2 being operated at its natural resonance frequency f_{R2}, but instead at an odd fraction thereof, the advantage will arise that the lower switching frequency reduces the switching losses in the switching elements T3 and T4 in the second half bridge 110-2 as compared with the pure resonant operation at f_{R2}, while at the same time the glow discharge current through the high-pressure lamp 120 is increased in comparison with the resonant operation by the factor of the fraction; i.e. in comparison with an operation at the actual resonance frequency, the glow discharge current is greater by a factor 3 in the case of excitation by merely ⅓of the resonance frequency.

2. Run-Up Mode After the glow discharge, the high-pressure lamp 120 enters a luminous arcing mode in which it initially has a very low burning voltage of approximately 15 V. A current flows already through the high-pressure lamp 120 both in the glow discharge and in the luminous arcing mode, so that the current control described above with reference to FIG. 1 is operational already in principle. The very low operating voltage which establishes itself in the luminous arcing mode, however, leads to a drop in the switching frequencies of the switching elements T1 and T2 in the first half bridge 110-1. This may proceed to the point that at the start of lamp operation, i.e. in the luminous arcing mode, the switching frequency may drop to below the resonance frequency of the first resonant circuit comprising the first coil L1 and the first capacitor C1 . This will then have the result that a stable current control is no longer possible. It was found, however, that a useful operation of the current control is nevertheless made possible if the minimum switch-on duration of the switching elements T1, T2 is limited in downward direction. This does give rise to an irregular switching pattern for the switching elements T1 and T2, as is shown in FIG. 3, with strong noise components in the lamp current, but the average lamp current remains continuously controllable. The irregular switching pattern manifests itself in the irregular time durations of the rising and falling edges in the current through the first coil L1, because the first switching element T1 is switched on and the second switching element T2 is switched off during each rising edge, whereas in the opposite case, i.e. during the falling edges, the first switching element T1 is switched off and the second switching element T2 is switched on.

3. Normal Operational Mode After the run-up phase, the high-pressure lamp 120 enters the normal operational mode. In this normal operational mode, the high-pressure lamp is supplied with a low-frequency alternating current whose basic frequency is given by the switching frequency of the switching elements T3 and T4 of the second half bridge 110-2.

FIG. 4 shows an example of a positive half wave of the pulsatory alternating current through the high-pressure lamp 120. The switching element T4 is switched on and the switching element T3 is switched off during the positive half wave. While the switching elements T3 and T4 of the second half bridge 110-2 are switched on and off alternately in accordance with the desired basic frequency of the lamp current, the duty cycles of the switching elements T1 and T2 of the first half bridge 110-1 are controlled by the current control described above with reference to FIG. 1 such that an average DC current level adjusts itself in the first coil L1, which level corresponds to the desired current through the high-pressure lamp 120.

It is apparent from FIG. 4 that the switching frequencies of the switching elements T1 and T2 are substantially higher than the switching frequencies of the switching elements T3 and T4. More precisely, the switching element T4 remains switched on throughout the time period covered by FIG. 4, and the switching element T3 remains switched off throughout this entire period, whereas the switching element T1 is switched on during each rising edge of the current through the first coil L1 and is switched off for the duration of the falling edges. By contrast, the switching element T2 is switched off during the rising edges of the current through the first coil L1 and switched on for the duration of the falling edges.

The high switching frequencies, in particular of the switching elements in the first half bridge 110-1, may give rise to high losses therein. These losses may be substantially reduced by a so-termed voltageless switching of the switching elements T1, T2. This voltageless switching may be achieved in that each switching element T1 and T2 is given a respective parallel capacitor C4 and C3, and in that the high-frequency alternating current through the first coil L1 passes the zero line both in downward and in upward direction in each switching cycle. To realize the latter, the first switching element T1 is first switched on and the second switching element T2 of the first half bridge 110-1 is switched off. This switching configuration achieves that the current through the first coil L1 rises to a high positive value. Once this current has reached a desired threshold value, the switching states of the switching elements T1 and T2 are changed over after a given delay time realized by the delay circuit 150, so that then the switching element T1 is switched off. The current, which first further flows from the half bridge 110-1 as in the first switching configuration, then starts to re-charge the capacitors C3 and C4. More accurately, the re-charging takes place such that the voltage across the capacitor C3, and thus at the output 112-1 of the first half bridge 110-1, drops, whereas the voltage across the capacitor C4 rises. When the voltage at the output 112-1 has reached the value “0”, a diode present in the switching element T2, if the latter is constructed as a MOSFET transistor, becomes conductive, and the current in the first coil L1 starts to decrease. Now the second switching element T2 can be switched on without losses.

The typical operating voltage of the high-pressure lamp 120 in the normal operational mode, i.e. of approximately 75 V, is now present across the capacitor C1. This voltage causes the current in the first coil L1 to decrease further until it finally drops below the zero line, as is shown in FIG. 4. Now the second switching element T2 of the first half bridge 110-1 can be switched off without losses. The current through the high-pressure lamp 120 and through the first coil L1 flows into the first half bridge 110-1 again starting from this moment and again starts to charge the capacitors C3 and C4, so that the voltage at the output 112-1 of the first half bridge rises again. When it finally reaches the level of the supply voltage again, a diode in the first switching element T1, if this is constructed as a MOSFET transistor, becomes conductive. The cycle described above with the current rise through the first coil L1 then starts from scratch again. A loss-free switching on and off of the switching elements T1 and T2 can be continually maintained in this manner.

After the current direction has been reversed, i.e. in the negative half wave, the switching element T4 is switched off and the switching element T3 of the second half bridge 110-2 is switched on. The first half bridge 110-1 is now controlled by the current control such that the average current flows into the first half bridge.

The capacitor C1 drains off the high-frequency component of the current through the first coil L1 to the reference potential (−). At the same time, the second coil L2 represents a barrier for any remaining portions of high-frequency components in the lamp current.

As was noted above, the second capacitor C2 with the second coil L2 forms a second resonant circuit whose resonance frequency typically is a multiple of the switching frequency of the first half bridge. In the normal operational mode, accordingly, the second resonant circuit is normally operated at a frequency far below its resonance frequency, which is why any remaining high-frequency current in the capacitor C2 is only very small. If, for example, the first capacitor C1 is chosen to be 150 nF and the second capacitor 82 pF, the remaining alternating current in the second capacitor C2 amounts to no more than approximately 0.1% of the alternating current through the first capacitor C1.

FIG. 5 shows a further embodiment of the circuit according to the invention. Its operation is the same as that of the embodiment shown in FIG. 1. The essential difference with the embodiment shown in FIG. 1 is that the second capacitor C2 is not connected to the reference potential (−) but lies in parallel to the high-pressure lamp 120. This circuit arrangement has the same effect as the circuit configuration shown in FIG. 1 at least in the ignition mode or generally in the case in which a high-frequency current flows through the capacitor C2, because the first capacitor C1 represents a short-circuit to the reference potential (−) for high-frequency currents. The second capacitor C2 would then also be connected—as in FIG. 1—between the junction point of the high-pressure lamp 120 and the second coil L1 on the one hand and the reference potential (−) on the other hand.

It was furthermore found that a loss-free switching of the switching elements T1 and T2 can also be realized with only one capacitor, in particular the third capacitor C3, in particular at high-frequency currents. The fourth capacitor C4 would then be unnecessary.

FIG. 6 shows a third embodiment of the circuit according to the invention. It differs from the first embodiment shown in FIG. 1 exclusively in that capacitors are also provided parallel to the switching elements of the second half bridge 110-2. In particular, a fifth capacitor C5 is connected in parallel to the third switching element T3, and a sixth capacitor C6 in parallel to the fourth switching element T4. These capacitors render possible a reduction in the switching losses of the switching elements T3 and T4, similar to the action of the capacitors C3 and C4. They are particularly advantageous in the ignition mode, because the losses in the switching elements are particularly high then because of the particularly high switching frequencies. The capacitors C5 and C6 in addition provide an advantageous reduction in the edge steepness of the voltage at the output of the half bridge 110-2. This again is advantageous for the suppression of HF interference.

The current control in the embodiments of FIGS. 5 and 6 operates in the same manner as the one described with reference to FIG. 1 above.

1. An electronic circuit (100) for operating a high-pressure lamp (120) in an ignition mode and a normal operational mode, comprising
a DC-AC converter comprising a first and a second half bridge (110-1, 110-2) which are connected in parallel between an operating potential (+) and a reference potential (−) for providing a suitable alternating current to the high-pressure lamp (120) in the two said operating modes; and
a series arrangement comprising a first coil (L1), followed by the high-pressure lamp (120), again followed by a second coil (L2), while the connection terminal of the first coil (L1) not connected to the high-pressure lamp (120) is connected to the output (112-1) of the first half bridge (110-1), and the connection terminal of the second coil (L2) not connected to the high-pressure lamp (120) is connected to the output (112-2) of the second half bridge (110-2), said outputs being each formed by a central tap of a half bridge;
characterized by a first capacitor (C1) which is connected in the path from the junction point of the first coil (L1) and the high-pressure lamp (120) either to the reference potential (−) or to the operating potential (+); and
a second capacitor (C2) which is connected in the path from the junction point of the high-pressure lamp (120) and the second coil (L2) either to the reference potential (−) or to the operating potential (+) or in parallel to the high-pressure lamp (120).

2. A circuit as claimed in claim 1, characterized in that a third capacitor (C3) is connected between the output (112-1) of the first half bridge (110-1) and either the operating potential (+) or the reference potential (−).

3. A circuit as claimed in claim 1, characterized in that a third capacitor (C3) is connected between the output (112-1) of the first half bridge (110-1) and the reference potential (−), and in that a fourth capacitor (C4) is connected between the operating potential (+) and the output (112-1) of the first half bridge (110-1).

4. A circuit as claimed in claim 1, characterized in that a fifth capacitor (C5) is connected between the output of the second half bridge (112-2) and the operating potential (+), and/or in that a sixth capacitor (C6) is connected between the reference potential (−) and the output (112-2) of the second half bridge (110-2).

5. A circuit as claimed in claim 1, characterized by
a sensor device (130) for generating a current-sensor signal which represents the value of the current through the first coil (L1); and by
a comparator device (140) for comparing the value represented by the current-sensor signal with a given reference current value I_{R} and for generating at least one control signal for controlling the level of the current through the first coil (L1) and through the high-pressure lamp (120) to the given reference current value I_{R} through a suitable variation of the duty cycles of the switching elements (T1, T2) of the first half bridge (110-1).

6. A circuit as claimed in claim 5, characterized in that the sensor device (130) is constructed as a magnetoresistive sensor.

7. A circuit as claimed in claim 5, characterized by a delay device (150) for delaying the control signal for controlling the switching elements (T1, T2) of the first half bridge (110-1) by a given delay time with respect to the moment when it is detected that the level exceeds the reference value I_{R} in upward or downward direction, which delay time is defined such that at least a desired critical damping establishes itself in a filter comprising the second coil (L2) and the first capacitor (C1), and that the current through the first coil (L1) changes its sign at least twice during a switching cycle of the switching elements (T1, T2) of the first half bridge.

8. A method of operating a high-pressure lamp (120) with a circuit as claimed in claim 1, characterized in that the first coil (L1) and the first capacitor (C1) together form a filter for filtering out at least substantially the AC component from the current flowing through the high-pressure lamp (120), which filter is supplied with a voltage provided by the first half bridge (110-1), whose frequency lies above the resonance frequency f_{R1} of the filter (L1, C1); and in that
the second coil (L2) and the second capacitor (C2) together form a resonant circuit which in the ignition mode is supplied with a voltage provided by the second half bridge (110-2), whose frequency corresponds to the resonance frequency f_{R2} of the resonant circuit (L2, C2) or to an odd fraction thereof, so as to generate an ignition voltage necessary for igniting the high-pressure lamp (120).

9. A method as claimed in claim 8, characterized in that the ignition mode is maintained for at least one second, and in that immediately after that a switch is made to the normal operational mode.

10. A method as claimed in claim 9, characterized in that after ignition of the high-pressure lamp (120) the switching frequency of the second half bridge (110-2), and thus the frequency of the current through the high-pressure lamp (120), is reduced.

11. A method as claimed in claim 8, characterized in that the switching elements (T1, T2, T3, T4) of the first half bridge (110-1) and/or the second half bridge(110-2) are operated by the principle of voltageless switching.
